(19) United States
(12) Patent Application Publication
(10) Pub. No.: US 2010/0042522 A1
(43) Pub. Date: Feb. 18, 2010

(54) AUTOMATIC ELECTRONIC REMINDER DELIVERY

(75) Inventors: Craig O'Brien, Windsor (CA); Aaren William Whitson, Tecumseh (CA); Mark Adam Wolf, Windsor (CA)

Correspondence Address: BROOKS KUSHMAN P.C., 1000 TOWN CENTER, TWENTY-SECOND FLOOR, SOUTHFIELD, MI, 48075, US

(73) Assignee: CREDIT MESSAGE INC., Windsor (CA)

(21) Appl. No.: 12/192,277

(22) Filed: Aug. 15, 2008

(51) Int. Cl. G06Q 40/00

(52) U.S. Cl. 705/34

(57) ABSTRACT

Users are sent electronic reminders informing them that outstanding debts are due. The user can customize the list of sent reminders to include some or all of the user's outstanding debt. The user can further select times for reminder delivery, and the user is notified for a period of time prior to the due date of debt that the debt is due. Once a debt has been paid, the user can notify the system sending the reminders that the debt is paid in order to stop the reminders from being sent.

### BACKGROUND OF THE INVENTION

### FIELD OF THE INVENTION

The illustrative embodiments relate to automatic electronic reminder delivery. More particularly, the illustrative embodiments relate to automatically delivering reminders to a user via an electronic medium.

### SUMMARY OF THE INVENTION

Many creditors and other people to whom money is paid are willing to provide customers with automatic reminders to pay bills. These reminders may take the form of emails or paper mail, and are typically sent some period of time before a bill is due, in order to give a debtor adequate time to make a payment. Although any one particular creditor may be willing to set up a reminder for the debt owed to them, consumers may wish to have a more comprehensive solution.

Additionally, consumers often have numerous bills to pay. If the reminders are sent, for example, via email, there may be no way of knowing if a particular bill has been paid, unless the consumer does some detailed checking. In other words, if four bill notices arrive from different creditors, and a debtor pays three of them, unless the debtor remembers to delete the reminder emails, there will still be four email reminders in the debtor's inbox.

Another possible problem is that a debtor may overlook a reminder. Existing reminder programs may only send a single reminder to the debtor. If the debtor fails to notice the reminder, the bill may go unpaid.

Further, if the reminder does not arrive at a convenient time, the reminder may go overlooked or get put off, and be forgotten. Typically, a debtor has no control over when a reminder should arrive.

The illustrative embodiments provide, among other things, the capabilities so send multiple reminders leading up to and after a due date, the capabilities to have a debtor designate arrival times for reminder messages, and/or the capabilities to confirm that a debt has been paid.

In one or more illustrative embodiments, a website or other service receives input including at least one preferred method of reminder delivery. Additionally or alternatively, the debtor can be provided with a list of common debt types, and select one or more types of debt from the list. Then, the debtor can input the actual debts associated with the common debt types.

The debtor may also be provided with an option to input if the debts are recurring, one time, etc. Alternatively, the website may recognize certain debt types as being yearly, monthly, one time, etc., based on the type. The website could provide a default listing based on the type, or automatically select a period of payment associated with a type of debt.

In one or more illustrative embodiments, a debtor will sign up for one or more reminders. The reminders may be delivered via email, via SMS message, or any other suitable electronic medium. In these illustrative embodiments, the reminder messages will begin arriving a certain number of days prior to the due date for a debt.

In at least one illustrative embodiment, the user can select how many days of reminders are desired. In at least one other illustrative embodiment, the reminders arrive for a predefined number of days leading up to the due date of the debt. Similarly, a period for reminders following the due date can be user defined or predetermined. Reminders also may not be sent at all following the due date.

According to at least one illustrative embodiment, a debtor may select one or more times for reminders to be delivered. In this manner, the debtor can ensure that the reminders arrive at convenient times when they are more likely to be noticed. Or, if the reminder is coming via SMS messaging, for example, the debtor may have the reminder arrive when the debtor is driving home from work, or at a similar time where the debtor knows that he or she will be on the road, and can easily divert to a location to pay a bill.

In one or more illustrative embodiments, the system that sends out the reminders may also receive a notification when a debt has been paid. In at least one embodiment, this notification is sent by a debtor clicking a link, button, etc. in a reminder email to cause a message to be sent to stop sending the reminders. If the delivery medium was, for example, an SMS message, the debtor could respond to the message with an appropriate response, such as “paid”, and the system could stop sending the reminders.

### BRIEF DESCRIPTION OF THE DRAWINGS

Other objects, aspects and characteristics of the illustrative embodiments will become apparent from the following detailed description of exemplary embodiments, when read in view of the accompanying drawings, in which:

FIG. 1 shows an illustrative first screen for input of exemplary information, including a delivery method;

FIG. 2 shows an illustrative second screen for input of exemplary information, including types of debt;

FIG. 3 shows an illustrative third screen for input of exemplary information, including a description of debt;

FIG. 4 shows an illustrative reminder; and

FIG. 5 shows an illustrative flow for an exemplary reminder distribution process.

### DETAILED DESCRIPTION OF THE PREFERRED EMBODIMENT(S)

The present invention is described herein in the context of particular exemplary illustrative embodiments. However, it will be recognized by those of ordinary skill in the art that modification, extensions and changes to the disclosed exemplary illustrative embodiments may be made without departing from the true scope and spirit of the instant invention. In short, the following descriptions are provided by way of example only, and the present invention is not limited to the particular illustrative embodiments disclosed herein.

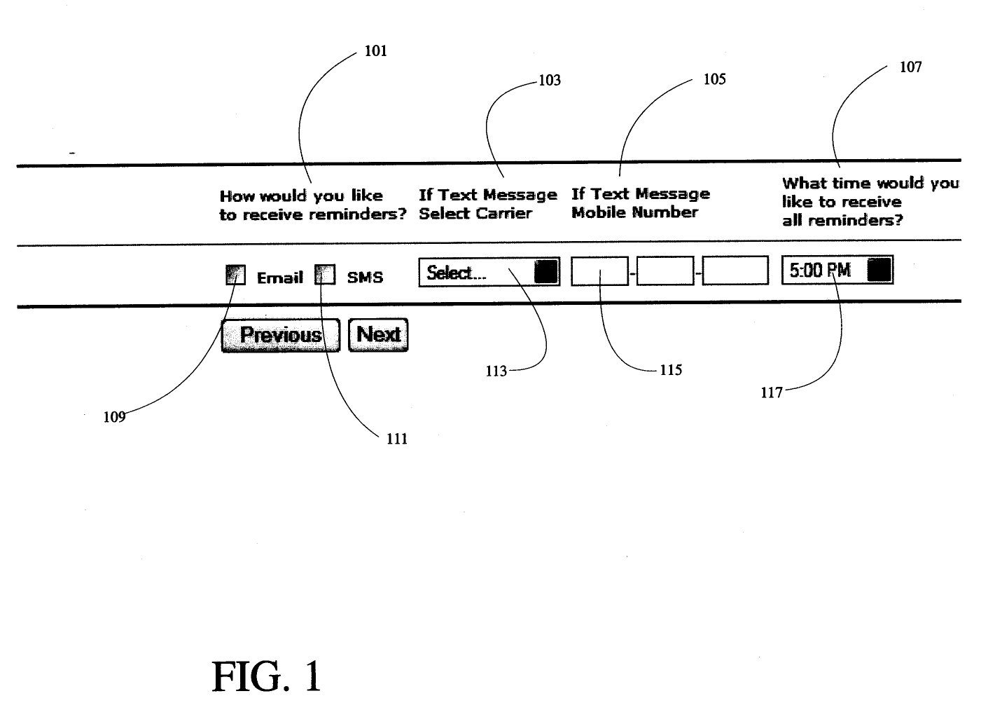

FIG. 1 shows an illustrative first screen for input of exemplary information, including a delivery method. One possible way for users to sign up for receipt of electronic reminders would be over the internet through a website. As part of an exemplary illustrative sign up process, FIG. 1 shows one screen that might be presented to users seeking to participate in an electronic reminder service.

First, the user can select 101 whether email 109 and/or SMS 111 delivery is requested. Other forms of electronic delivery are also contemplated. If the user opts to go with email delivery, the user is asked to enter a carrier 103. In this illustrative embodiment, a drop down list of supported carriers 113 is provided. Additionally, the user is asked to enter a phone number 105 in the boxes 115 provided.

Although the user is not requested to enter an email address on this page, such inquiry could be made. In this illustrative example, the user has entered an email address as part of a log-in procedure, and thus the email address has already been entered. Additionally, more than one email or phone number to which reminders are to be sent could be entered.

Finally, the user is asked at what time of day they would like to receive reminders 107. The user can select from a drop down list of times 117, or it would be possible to simply have the user enter a specific time. This feature allows the user to customize when reminders are received, so that the user is more likely to receive the reminders at a time that is convenient for reading and responding to the reminders.

The system receives and stores all of the entered information and associates it with the particular user's profile and reminder requests, so that reminders can be sent out to the user as needed.

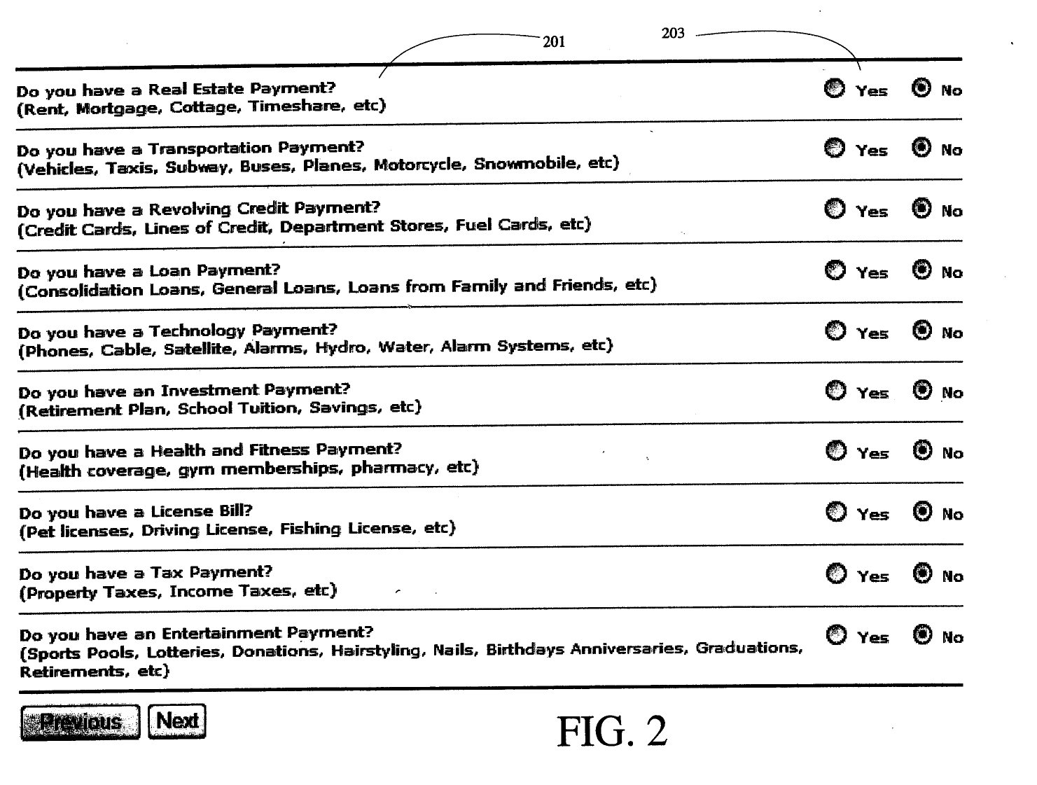

FIG. 2 shows an illustrative second screen for input of exemplary information, including types of debt. In this illustrative embodiment, the user is provided with a laundry list of possible types of debt 201. For each debt type, the user is asked to select whether or not a bill of that type exists and needs a reminder 203. Providing such a list encourages the user to perform a brief but detailed analysis of all debt types, so the user ensures that nothing gets overlooked. The non-exhaustive list includes real estate, transportation, credit, loan, technology, investment, health and fitness, licenses, taxes and entertainment payments. As an alternative, the user could simply be provided with a blank list, which the user could fill out at his or her own discretion.

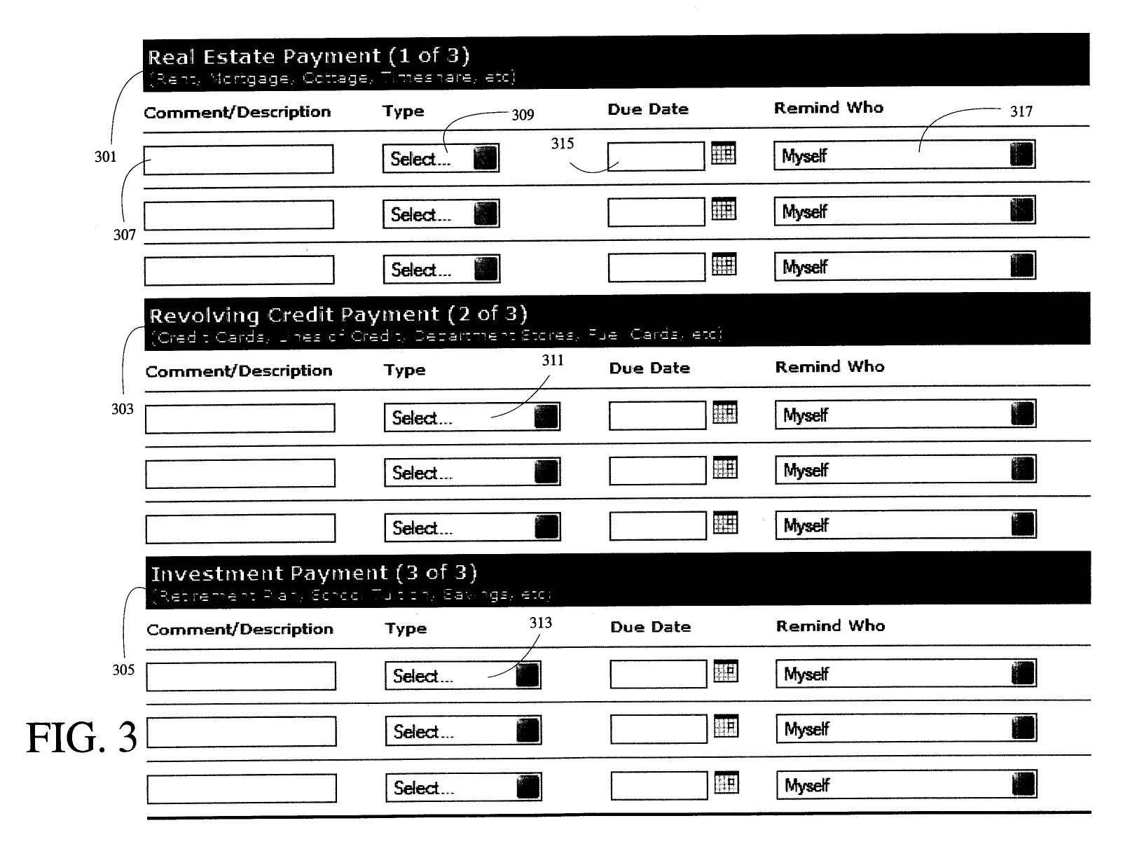

FIG. 3 shows an illustrative third screen for input of exemplary information, including a description of debt.

For each type of debt selected by the user, additional information fields 301, 303, 305 are provided. Each field corresponds to one type of debt selected from the list provided in FIG. 2.

For each field, the user is asked to enter a description of the debt 307. This allows the user to customize the reminders sent so that it is more likely the user will recognize the reminders. Additionally, the user is provided with dropdown boxes 309, 311, 313 containing further information about the debt. For example, under the real estate header 301, the drop down box 309 might have options such as “rent,” “mortgage,” etc. The box 311 might have options such as “home equity,” or “credit card,” and the box 313 might have options such as “401k,” or “stock trading account.”

The user can also enter a due date 315 so that the system knows when the payment is to be made. Certain payments may only be due quarterly or yearly (or any other non-monthly form) and there may be an additional option (not shown) to notify the system that this is not a monthly payment.

Finally, the user is given an option of who to remind 317. This could be one or more user accounts for reminder, or could include secondary people, such as a spouse or a parent. This helps ensure that all appropriate parties are reminded to pay the debt. Further, if any of the parties pays the debt and clicks the appropriate notification, then updated messages could be sent to all parties letting them know the debt has been satisfied.

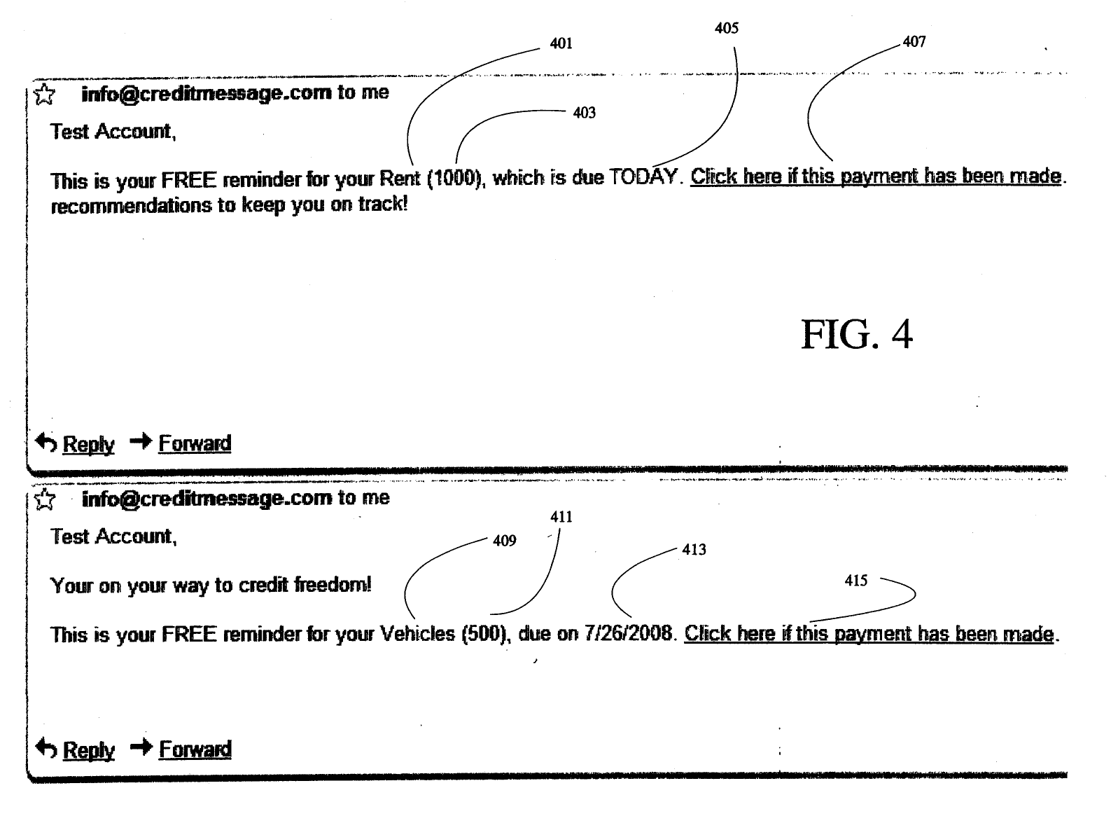

FIG. 4 shows an illustrative reminder sent to a user in one illustrative embodiment. Included in this exemplary reminder is a description of the bill type 401, 409. This lets the user know to what payment the reminder corresponds. Also included is a dollar amount 403, 411 that is due, so the user knows how much they have to pay.

Additionally, it may be desirable to send out reminders for some period leading up to the due date. This could be a user defined or pre-defined period. Since the reminders may not only arrive on the actual due date, a due date 405, 413 is included so the user knows when the debt is due.

Finally, the user is given a clickable link 407, 415 on which they can click to notify the reporting system that a bill has been paid. This helps stop reminders from coming if the debt is paid early, and helps the user keep track of which debts have been paid. Clicking on this link could also cause updated reminders to be sent to all selected parties, so that everyone receiving the reminder knows the debt has been paid and is no longer in need of payment.

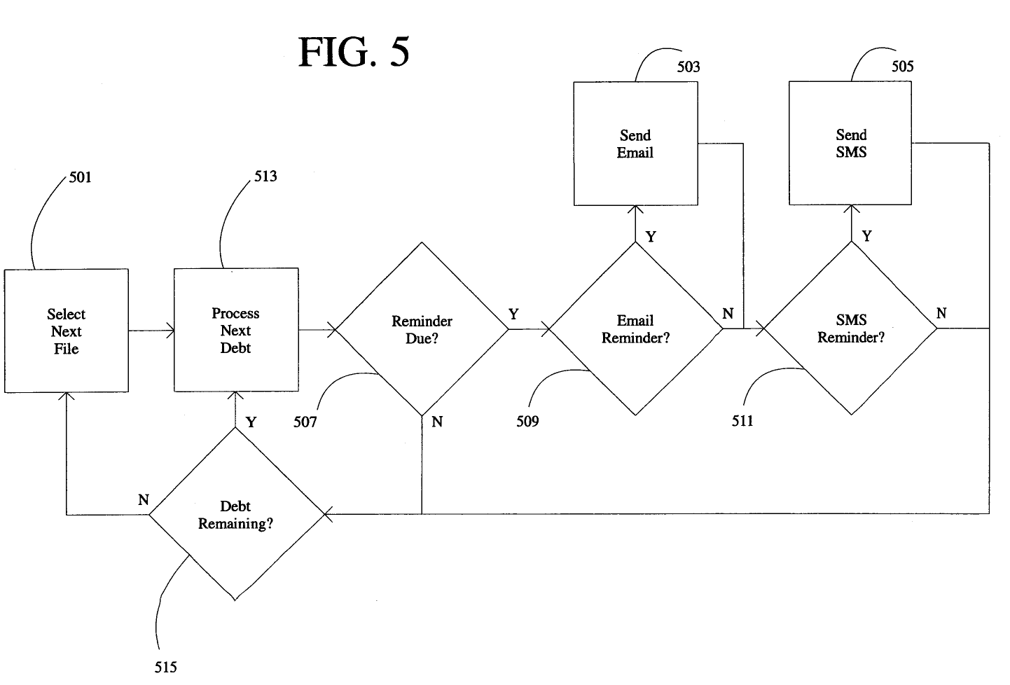

FIG. 5 shows an illustrative flow for an exemplary reminder distribution process. The system that sends reminders selects a user file from, for example, a database. Polling the database with regularity helps ensure that new users who may have just joined do not miss upcoming due dates.

Once a particular file is selected, the system selects the first or next debt associated with the file 513. Then, the system checks to see if a reminder date is coming up 507. Within a predefined or user-defined number of days from the due date, this check should return yes. This ensures that, for some period of time prior to the due date, reminders are sent to the user daily (or in some other increment of time) to let the user know that a due date is approaching. If that debt does not have a reminder associated with it, the system checks to see if there are any debts remaining that are associated with the file 515. If not, the system will select the next user's file, otherwise, the system process the next debt.

If a due date is upcoming, the system checks to see if an email reminder is desired 509. If the user requested an email, then an email reminder is sent 503, otherwise the system checks for an SMS reminder request 511. If the user has requested an SMS reminder, then an SMS reminder is sent. The system then checks for debts remaining on the file, and proceeds according to the results of that check. While an exemplary illustrative example of one algorithm for processing reminders has been shown, it is intended to be an example and is not to limit the scope of the invention.

It is to be understood that the invention is not to be limited to the disclosed exemplary illustrative non-limiting implementations. On the contrary, the invention is intended to cover various modifications and equivalent arrangements included within the scope of the claims.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A computer readable storage medium storing instructions that, when executed by a processor, cause the computer to perform a method comprising:
receiving at least one of an email address or a phone number;
receiving an entry of a debt including at least a due date;
receiving a message delivery time;
associating the received information with a user account; and
beginning a period of one or more days prior to a received due date, sending a reminder to at least one of the received email address or phone number notifying a user that a debt is due, wherein the reminder is sent at approximately the received desired message delivery time.

2. The computer readable storage medium of claim 1, wherein the computer is further caused to perform the method including:
for a period of time leading up to a received due date, sending daily reminders to at least one of the received email address or phone number notifying the user that the debt is due.

3. The computer readable storage medium of claim 1, wherein the computer is further caused to perform the method including:
receiving notification that a debt has been paid; and
ceasing sending of the reminders notifying a user that the debt corresponding to the debt for which notification was received is due.

4. The computer readable storage medium of claim 1, wherein the computer is further caused to perform the method including:
receiving at least one additional email address or additional phone number; and
beginning a period of one or more days prior to a received due date, sending a reminder to at least one of the received additional email address or additional phone number notifying a user that a debt is due, wherein the reminder is sent at approximately the received desired message delivery time.

5. The computer readable storage medium of claim 3, wherein the receiving notification further comprises receiving an electronic mail notification.

6. The computer readable storage medium of claim 3, wherein the receiving notification further comprises receiving an SMS message notification.

7. A computer implemented method of sending a reminder performed by at least one centralized computer, comprising:
receiving at least one of an email address or a phone number;
receiving an entry of a debt including at least a due date;
receiving a message delivery time;
associating the received information with a user account;
storing the received information in a memory of the at least one centralized computer; and
beginning a period of one or more days prior to a received due date, sending a reminder to at least one of the received email address or phone number notifying a user that a debt is due, wherein the reminder is sent at approximately the received desired message delivery time.

8. The computer implemented method of claim 7 including:
for a period of time leading up to a received due date, sending daily reminders to at least one of the received email address or phone number notifying the user that the debt is due.

9. computer implemented method of claim 7 including:
receiving notification that a debt has been paid; and
ceasing sending of the reminders notifying a user that the debt corresponding to the debt for which notification was received is due.

10. The computer implemented method of claim 7 including:
receiving at least one additional email address or additional phone number; and
beginning a period of one or more days prior to a received due date, sending a reminder to at least one of the received additional email address or additional phone number notifying a user that a debt is due, wherein the reminder is sent at approximately the received desired message delivery time.

11. The computer implemented method of claim 7, wherein the receiving notification further comprises receiving an electronic mail notification.

12. The computer implemented method of claim 7, wherein the receiving notification further comprises receiving an SMS message notification.
